(19) United States
(12) Patent Application Publication
(10) Pub. No.: US 2026/0113266 A1
(43) Pub. Date: Apr. 23, 2026

(54) TOPOLOGY SPANNING IN COMMUNICATION NETWORK IMPLEMENTATION

(71) Applicant: Ceragon Networks Ltd., Rosh HaAyin (IL)

(72) Inventor: Tzalik MAIMON, Tel Aviv (IL)

(73) Assignee: Ceragon Networks Ltd., Rosh HaAyin (IL)

(21) Appl. No.: 19/362,602

(22) Filed: Oct. 20, 2025

Related U.S. Application Data
(60) Provisional application No. 63/709,457, filed on Oct. 20, 2024.

(51) Int. Cl. H04L 45/036; H04L 45/12

(52) U.S. Cl. CPC H04L 45/036; H04L 45/123

(57) ABSTRACT

A method of building a communication network having core and optional vertices, and edges having costs. The network has feasibility requirements including capacity, latency, a maximum aggregation and a reliability. An initial solution is made by connecting edges to fulfil the feasibility requirements, prioritizing edges between core vertices as opposed to edges between optional vertices, then adding unconnected vertices one by one. The edges are ordered according to cost and the costliest edge are removed one by one, each time checking whether the feasibility requirements are still met. If the feasibility requirements are met then removal of the edge is confirmed, otherwise the edge is reinstated, and the procedure is continued with the remaining edges until all edges that can be removed while maintaining said feasibility requirements are removed. Then the network is built with the vertices as the nodes and the remaining edges are the communication links.

### RELATED APPLICATION

This application claims the benefit of priority of U.S. Provisional Patent Application No. 63/709,457 filed on Oct. 20, 2024, the contents of which are incorporated herein by reference in their entirety.

### FIELD AND BACKGROUND OF THE INVENTION

The present invention, in some embodiments thereof, relates to communication networks and their efficient implementation and, more particularly, but not exclusively, to a method of topology spanning for the same.

The problem of network planning is a complex problem that appears in all communication networks. From Tier 1 networks to private networks, area planning has a great effect on the performance and cost of the network. The complexity of the problem arises from the multiple interacting factors that such planning needs to consider. This includes capacity demand, resource allocation, redundancy, cost of installation and maintenance, availability and more. The key to successful area planning lies in finding a balance in which all the requirements from the network are met on the one hand, but on the other hand it must also be cost-effective. While it is possible to meet most requirements by allocating plenty of resources, this approach is very expensive. Conversely, trying to minimize resources might result in a network that cannot meet its needs.

The problem is well-studied and well-known in the field of communication networks. The problem is even more difficult for wireless networks that use Radio Frequencies (RF). In such networks, there are even more considerations such as interference, signal degradation due to environmental changes, Line-of-Sight (LOS) and more. Keeping to the network requirements while both lowering the cost and considering all the additional factors that arise from RF is a challenge. This is, in fact, known in computational theory. Some requirements in the planning make the problem NP-hard, and this has pushed many in the past to turn to stochastic, probabilistic and machine learning techniques to find a solution. These directions each have disadvantages.

### SUMMARY OF THE INVENTION

The present embodiments provide ways of building a communications network that fulfils its requirements and minimizes its costs at the same time. Graph theory is used to design the network and then the vertices of the graph become the nodes of the network and the edges of the graphs become the communication links as the network is built according to the design.

According to an aspect of some embodiments of the present invention there is provided a method of building a communication network, the network having a first number of predefined core vertices and a second number of optional vertices, and edges extending directionally between ones of said vertices, each edge having a cost, the network predefined feasibility requirements, said feasibility requirements comprising at least one of a capacity requirement, a maximum allowed latency, a maximum aggregation and a reliability, the method comprising:
building an initial solution by connecting edges between said vertices such that said initial solution fulfils said feasibility requirements, said initial solution prioritizing edges between two of said core vertices and deprioritizing edges between two optional vertices, then adding unconnected vertices one by one;
ordering said edges according to cost;
tentatively removing a costliest one of said edges and checking whether said feasibility requirements are still met;
if said feasibility requirements are met then accepting the removal of said costliest edge, otherwise reinstating said edge;
continuing with a next costliest edge until all edges that can be removed while maintaining said feasibility requirements are removed and remaining ones of said edges are maintained; and
completing said communication network such that each remaining edge is implemented as a communication link.

In embodiments, one or more vertices are disconnected after removing edges and maintaining feasibility requirements, and the method comprises sequentially connecting said disconnected vertices by spanning said network using a breadth first search (BFS) from a respective disconnected vertex, said search comprising finding potential parent vertices of said respective disconnected vertex and adding edges from said respective disconnect vertices to said parent vertices, and retaining lowest cost ones of said potential edges, provided said feasibility requirement are complied with.

Embodiments may involve continuing to reconnect disconnected vertices until all vertices are connected to said network, and if it is not possible to connect all vertices and comply with said feasibility requirements then determining that said communication network is unfeasible.

The method may involve adding a new vertex, and spanning said network using a breadth first search (BFS) from said new vertex, said search comprising adding from said new vertex to respective potential parent vertices of said new vertex and retaining lowest cost ones of said edges, provided said feasibility requirement are complied with.

The method may involve adding a new vertex and edges on either side as a potential new parent vertex.

The method may involve using said maximum allowed latency as a cost.

The method may treat aggregation as a requirement.

Redundancy may be treated as a requirement, such that there are always at least two alternative independent routes between each vertex.

According to a second aspect of the present invention there is provided a method of building an RF communication network, the network having a first number of predefined core vertices and a second number of optional vertices, and edges extending directionally between ones of said vertices, each edge having a cost, the network predefined feasibility requirements, said feasibility requirements comprising at least one of a capacity requirement, a maximum allowed latency, a maximum aggregation and a reliability, the method comprising:
randomly generating a plurality of spans of said vertices;
evaluating said plurality of spans for fitness;
using said fitness, pairing solutions and creating crossover solutions to add to said spans;
performing a mutation on some of said spans;
selecting a new generation from said spans using said fitness evaluation and continuing with further generations until a stop criterion is met; and
completing said RF communication network such that edges in a last remaining span are implemented as communication links in said RF network.

According to a third aspect of the present invention there is provided a method of building an RF communication network, the network having a first number of predefined core vertices and a second number of optional vertices, and edges extending directionally between ones of said vertices, each edge having a cost, the network predefined feasibility requirements, said feasibility requirements comprising at least one of a capacity requirement, a maximum allowed latency, a maximum aggregation and a reliability, the method comprising:
using a deterministic algorithm to find a first optimum solution for a feasible spanning of said network;
using a genetic algorithm to find a second optimum solution for a feasible spanning of said network;
selecting between said first optimum solution and said second optimum solution; and
building said RF communication network such that edges of said selected optimum solution are implemented as communication links in said RF network.

The deterministic algorithm may involve the following:
building an initial solution by connecting edges between said vertices such that said initial solution fulfils said feasibility requirements, said initial solution prioritizing edges between two of said core vertices and deprioritizing edges between two optional vertices, then adding unconnected vertices one by one;
ordering said edges according to cost;
tentatively removing a costliest one of said edges and checking whether said feasibility requirements are still met;
if said feasibility requirements are met then accepting the removal of said costliest edge, otherwise reinstating said edge; and
continuing with a next costliest edge until all edges that can be removed while maintaining said feasibility requirements are removed and remaining ones of said edges are maintained.

The genetic algorithm may involve:
randomly generating a plurality of spans of said vertices;
evaluating said plurality of spans for fitness;
using said fitness, pairing solutions and creating crossover solutions to add to said spans;
performing a mutation on some of said spans;
selecting a new generation from said spans using said fitness evaluation and continuing with further generations until a stop criterion is met.

The invention may extend to an R.F. network constructed using any of the methods discussed.

The invention may extend to an R.F. network in which at least one communication node is added as a new vertex using the techniques for adding a new vertex discussed herein.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram of a directed graph;

FIG. 2 is a simplified diagram of a directed multigraph, with bidirectional links;

FIG. 3 is a simplified flow chart of a deterministic algorithm for building an RF network according to embodiments of the present invention;

FIG. 4 is a simplified flow chart illustrating addition of new or disconnected vertices to a network spanner produced using the procedure of FIG. 3;

FIG. 5 is a simplified flow chart illustrating a genetic algorithm for building an RF network according to embodiments of the present invention; and

FIG. 6 is a simplified diagram illustrating a procedure for combining the deterministic and genetic algorithms into a further procedure for building an RF network according to embodiments of the present invention.

### DESCRIPTION OF SPECIFIC EMBODIMENTS OF THE INVENTION

The present invention, in some embodiments thereof, relates to communication networks and their efficient implementation and, more particularly, but not exclusively, to a method of topology spanning for the same.

A method is disclosed of building a communication network having core and optional vertices, and edges having costs. The network has feasibility requirements including capacity, latency, a maximum aggregation and a reliability. An initial solution is made by connecting edges to fulfil the feasibility requirements, prioritizing edges between core vertices as opposed to edges between optional vertices, then adding unconnected vertices one by one. The edges are ordered according to cost and the costliest edge are removed one by one, each time checking whether the feasibility requirements are still met. If the feasibility requirements are met then removal of the edge is confirmed, otherwise the edge is reinstated, and the procedure is continued with the remaining edges until a state is reached in which all the edges that can be removed while maintaining the feasibility requirements, are in fact removed. Then the network is built with the vertices as the nodes, and the remaining edges form the actual communication links.

A deterministic solution according to the present embodiments may optimize between all factors given as costs or considerations for an RF network. It gives a topology which supports all the requirements for the network as well as minimizing any cost factor given. In doing so, the present solution may minimize elements that hinder the functionality of the network, such as. interference.

We are given a sets of nodes, each of which can be either required or optional. We are also given a set of cores and optional links. The purpose is to choose what links to use in order to connect all required nodes of the network to the cores. Optional nodes may appear in the output of the algorithm but are not required.

A deterministic solution according to the present embodiments may hope to approximate an optimal solution due to the complexity of the problem. And so, a second embodiment disclosed herein is a Genetic Algorithm. In this algorithm, we describe the four stages of a genetic algorithm in terms of the problem of topology planning for RF communication networks. The algorithm we offer may converge onto valid solutions for area planning. The optimality of the solutions is random and approximates the optimal solution. In an embodiment, both schemes are used to find which produces the better solution. Between the two schemes we may expect a valid solution which may be a good approximation for the optimal solution.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

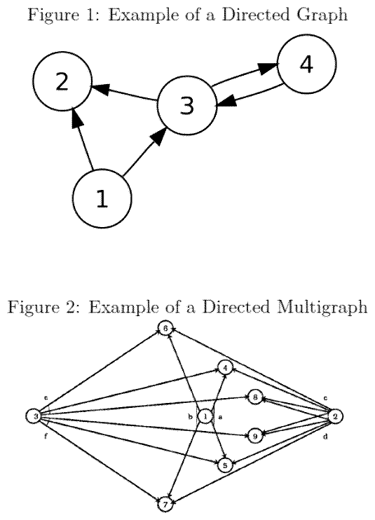

Referring now to the drawings, FIG. 1 illustrates an exemplary directed Graph and FIG. 2 illustrates an exemplary directed Multigraph. G=(V, E) defines a graph with a set of vertices (nodes) V and a set of edges E such that each edge e∈E is represented as a pair of vertices from V, e.g. (v; u) is the edge going out from v and is directed towards u. This is called a “directed edge” and is exemplified in FIG. 1. If the edge is not directed (that is the direction has no meaning) then the edges (v; u) and (u; v) are in fact the same edge. A multigraph is a graph which allows multiple edges between two vertices, and is exemplified by FIG. 2. We denote all edges in a set of edges E which are incoming on a vertex v as \vec{E}(v). In the same manner, the outgoing edges from a vertex v are denoted [symbol] )v).

### The Degree of a Vertex and the Degree of a Graph

The degree of a vertex v is the number of edges that are adjacent to v or also the number of neighbors v has in G. Usually, we denote the degree of v as Δ(v). In a directed graph (a graph where the edges are directed) we can discuss the out-degree or in-degree of a vertex, that is how many adjacent edges are directed from v or towards v, respectively. We define the degree of a graph G as Δ(G)=max(Δ(v)|v∈V (G)).

Distance in a Graph and k-Hop-Neighborhood

A distance in a graph between two vertices is the shortest path between those two vertices. In a directed graph, a directed path allows only the use of edges all of the same direction (either all in-going or all out-going). A k-hop neighborhood of a vertex v is the set of all vertices in a graph that are at a distance at most k from v, e.g. the 1-hop-neighborhood of a vertex is the set of its immediate neighbors.

### Problem Definition

In this section we give a formal definition for the problem of area planning in terms of graph theory. The input is a graph G=(V, E) where each vertex is a node or a core. The set of cores is given as S. We denote V=(Vo, Vr) where Vo is the set of optional vertices and Vr is the set of required vertices. We wish to find a subgraph H∈G where Vr⊆V (H)⊆V (G) and E(H)⊆E(G). The spanner H must uphold all the requirements of the network, or in other words, H must be feasible. Furthermore, given a cost function CF_{H} for each edge in a subgraph H, we wish to minimize max_{e∈H}CF_{H}(e). We can formulate the problem as finding whether min_{H∈G}(max_{e∈H}CF_{H}(e)|H is feasible). In the present embodiments we consider the following requirements for feasibility of a subgraph:
1. Capacity Demand—This is given as a constant c(v) for each v∈Vr.

Note that capacity demand does not render a network unfeasible. The significance is only in terms of more costly links. Therefore, in this disclosure we regard capacity as an element in the cost function. A single link that connects many stations would need the sum of the capacities of all the stations
2. Latency (Hops)—This is given as an integer α>0. We require
   ∀ν∈V(H), dist_{H}(v,S)≤α. All nodes can be reached from all other nodes by a maximum a of hops.
3. Aggregation—This is given as integer δ>1. We require Δ(H)≤δ.
4. Reliability—For each vertex v, given an integer k(v)≥1, we may build a topology such that there are k distinct paths from v to the subset S in order to provide redundancy or guarantee capacity. Here, distinct paths p₁, p₂ are paths with no shared edges among them, that is, E(p₁)∩E(p₂)=0. Note, though, that the paths can share vertices.

Unlike feasibility, the cost function CF does not need to be predefined. The only requirement is that CF may induce a lexicographic order to edges in a graph. Our general approach is first to build a feasible solution and then update it to lower the maximum cost of its edges. Updates are done while retaining feasibility.

### Solution Overview

The problem of area planning under the requirements described above is proven to be NP-hard. In fact, even a more relaxed problem of finding a Minimum Spanning Tree (MST) with a given bounded degree is also shown to be NP-hard due to its simple reduction to the Hamiltonian Path problem. We offer an approximation algorithm for the problem. Followed are the general steps we take in our algorithm:
1. Scan G—the input graph, starting from the set S of the network core. We build a spanning forest H of G. In each phase we add the vertices of the next rank in the forest by matching them to vertices in H. This is done by building a bipartite graph M between vertices in H and the vertices of the new rank and finding a Minimum-Weighted Maximum-Matching (MWMM) on M. In other words, the algorithm builds a maximal bipartite graph and then uses MWMM to redo it to reduce the costs—so high cost links get discarded wherever it can find a cheaper alternative that still links everything.

If, by the end of a iterations there are vertices in Vr which are not connected to H, we treat each individually by trying to make changes in H such that we can connect all vertices in Vr, Vr being the required vertices. If we cannot connect all vertices in Vr this way, we return that the network is unfeasible. Otherwise, we move to the next step.
2. We iteratively try to save the cost of the most costly edge e=(p, v) by removing it and trying to reconnect p to H. If we fail, we still attempt to find the next most costly edge while ignoring e. 3. We iterate on the vertices in H. For each vertex v, we find k(v)−1 additional distinct paths to S while adding edges as required. This is done by removing existing paths between v and S and trying to reconnect v to H using the least costly path. Some feasibility requirements might no longer be considered for the alternative paths.

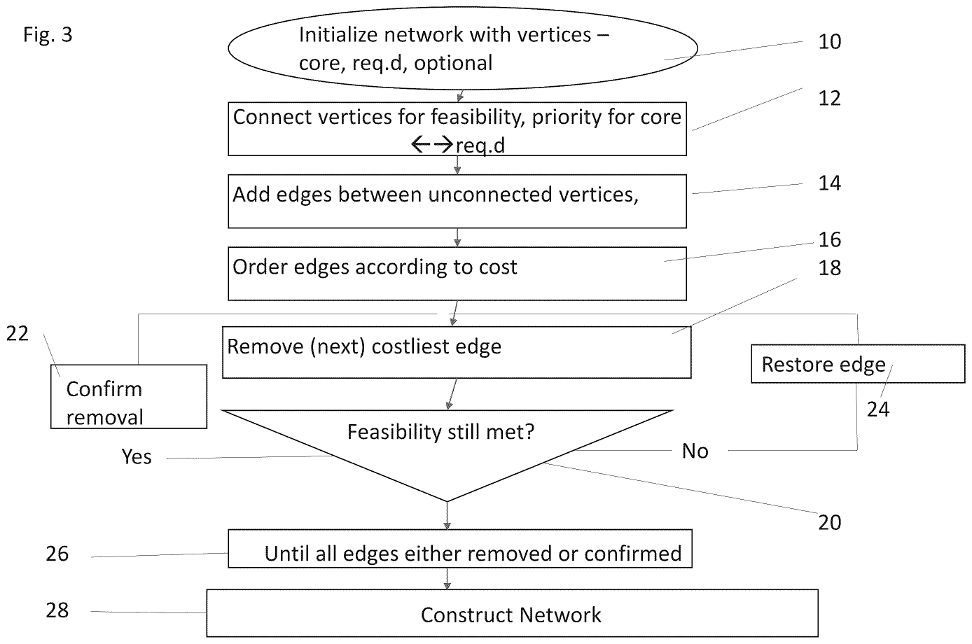

Referring now to FIG. 3, a method of building a communication network is illustrated as a simplified flow chart. The network is initialized 10 with a certain number of predefined core vertices and a certain number of optional vertices. The network includes edges extending directionally between various nodes, and each edge has a cost. The network is given certain feasibility requirements, which may include one or more of a capacity requirement, a maximum allowed latency, a maximum aggregation and a reliability.

In box 12, an initial solution is made by connecting edges between the various vertices so as to fulfil the feasibility requirements. The initial solution prioritizes edges between core vertices and deprioritizes edges between two optional vertices. In box 14, further edges are added between remaining unconnected vertices one by one.
ordering said edges according to cost;

In box 16, edges are then ordered according to cost.

In the loop including boxes, 18, 20, 22 and 24, the costliest edge is then tentatively removed. It is checked whether the feasibility requirements are still met without the edge, and if the feasibility requirements are met then the removal is confirmed. Otherwise the edge is retained. The loop continues with the next costliest edge until all edges that can be removed while maintaining the feasibility requirements are removed. The result is to be left with the edges that cannot be removed without prejudicing the feasibility of the network—box 26.

Finally,—box 28—the communication network is constructed physically with each remaining edge being a communication link in the network.

### Building a Feasible Network

In greater detail, we attempt to span a feasible network. The algorithm progresses in iterations. Let Ti be the spanning forest at iteration i. We define T₀ as the set of trees {{v}|v∈S}. Let L∈G be the set of vertices with distance exactly 1 from Tᵢ₋₁. Let Z∈Tᵢ₋₁ be the set of vertices with distance exactly 1 from L. We define a bipartite graph M=P∪C where C=L and the set P is constructed as follows. Let p∈Z be a vertex with degree Δtᵢ₋₁ (p) and rank rTᵢ₋₁ (p). If rTᵢ₋₁ (p)<α, we make δ−Δtᵢ₋₁ (p) copies of p in P. We add an edge to M between a vertex u∈L and a vertex w∈P if there is an edge in G between u and the original vertex p from which we created w.

We now execute a Minimum Weight Maximum Matching (MWMM) on M where we try to maximize the cardinality of matched vertices from C, that is to say to obtain a maximal number of possible pairs. This is done using the Hopcroft-Karp (HK) Algorithm, as disclosed in Ravindra K. Ahuja, Thomas L. Magnanti, and James B. Orlin, Network flows—theory, algorithms and applications. Prentice Hall, 1993 the contents of which are hereby incorporated herein by reference. HK is an enhanced version of the Hungarian algorithm, and HK finds the minimum cost version of the pairing. The Hungarian algorithm, or Hungarian method, is a combinatorial optimization algorithm that solves the assignment problem in polynomial time

We define the weight function for the MWMM algorithm. Let e=(u,w)|u∈P, w∈C be an edge in G with a cost CF(e). Then the weight of e in M is <PW(e); spare(,w),α−r(u);CF(e)>

where:

$$PW ( e ) = \{ \begin{matrix}0 & if u , w ∈ {V}_{r} \\ 1 & if u , w ∈ {V}_{o} \\ 2 & otherwise\end{matrix} \qquad ( 1 )$$

spare(w) is the number of neighbors of w in Vᵣ which are not included in Tᵢ₋₁.
r(x) is the rank of u according to Tᵢ₋₁.

The above allows to add more variables as costs. For example, if a particular connection requires building a new link, we can give a cost to the building of the link and add the new cost as an integer alongside the existing cost variable. Then we can reorder the variables so that building a new link is always more expensive than any link that can be added to the existing infrastructure, and make our decision regarding the particular connection accordingly. That is to say, if we can fulfil the requirements by modifying existing links, then modification is preferred.

In this sense, we first prioritize vertices which are required. Then, we prioritize vertices that have fewer options to connect in future iterations. Then, we prioritize vertices which are closer to violating the α requirement. And lastly, we consider the cost e. Let M′∈M be the resulting matching. Then Ti=Tᵢ₋₁∪M₀.

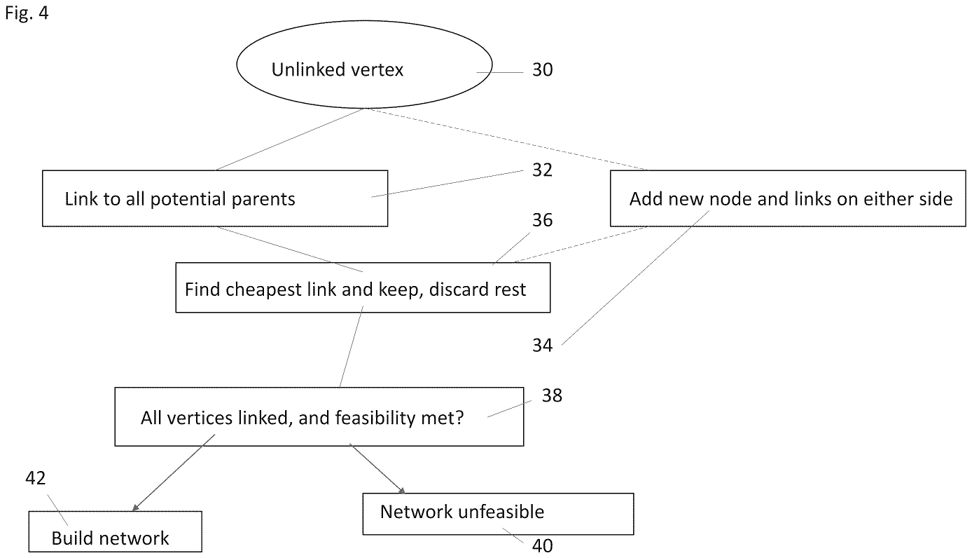

Reference is now made to FIG. 4, which is a simplified flow chart illustrating an extension of the flow chart shown in FIG. 3 to accommodate unconnected vertices. The unconnected vertices may simply be left over from the initial process since the network was feasible without them, or the issue may be adding new vertices later on. The procedure of FIG. 4 may thus occur either before or after the building of the physical network and may be followed by modification of an existing network. Vertices from L which were not matched in the preceding stages are left for later iterations. Any vertices in Vr which are left unconnected by the end of α iterations are marked as red vertices. We then try and reconnect the red vertices to H=T_{α} a single red vertex at a time. Referring to FIG. 4, box 30 relates to such an unmatched vertex. In box 32 the vertex is given an edge to each potential parent, that is each vertex in the spanner that could reasonably link to it. Each edge has a cost—box 34—and the cheapest link is then kept, the others being discarded. In some cases, especially in cases where the vertex in question is at an extreme edge of the network, it may be worth trying to build a new vertex with links on either side, to reach the unmatched vertex—box 36. The new vertex with two links generally has a higher cost than a single link but in some cases may be the cheapest way to link to the unmatched vertex. The algorithm is discussed in greater detail hereinbelow.

The procedure continues until all unlinked vertices have been dealt with and there are no more unlinked vertices—box 38. As will be discussed in greater detail below it may not always be possible to link all the vertices and still meet the feasibility requirements. In such a case the network is deemed unfeasible—box 40. If the network is feasible then it may be built—box 42, or for that matter modified if already built.

In greater detail, if we fail to connect a red vertex, we continue to try the next one. If we succeed in connecting a red vertex, we may then try previously failed red vertices again as the updated spanner might have legal connections for them. If all remaining red vertices were tried and no further connections can be achieved, then as per box 40, we return Infeasible Network. In such a case, all the pairings have been made and there are still one or more vertices that are left unconnected, mainly at the edges. We return the spanner as successful if the set of red vertices empties and proceed to box 42.

### Connect a Red Vertex

The procedure of FIG. 4 is now considered in greater detail. Given a legal spanner H and a vertex w∉H, we devise an algorithm that attempts to connect w to H by building new spanner H′ such that w∪Vᵣ(H)∈H′ and H′ is feasible in terms of a and δ. We say that the spanner H′ is whole in this case. The update is found using the MWMM algorithm on a bipartite graph M=P∪C. Initially, P=0, C={w}. The algorithm iteratively expands the subsets using vertices from P and C. As we add vertices to M, we also maintain a tree T that represents the expansion. Initially, T={w}.

### Finding Potential Parents

We define a potential parent of a vertex v as any vertex u∈H that is not a child of v in H, and such that there is a path Q∈G between u and v where Q∩H⊆{u,v}. That is, all vertices in Q are not in H other than u and v. Specifically, any node to which the red vertex, or for that matter, a new vertex, could be linked to is a potential parent. The procedure goes on to to find the link which is cheapest among the potential links.

We find the potential parents of v by spanning a BFS rooted in v, thus finding shortest paths from v to H. BFS, or Breadth-First Search, is a vertex-based technique for finding the shortest path in the graph. It uses a Queue data structure that follows a first in first out procedure. In BFS, one vertex is selected at a time when it is visited and marked, then its adjacent vertices are visited and stored in the queue. We initialize a new graph G=G. For each leaf u in the BFS that is not a child of v according to H, we contract the path from v to u to a single edge in G. At the present stage it is possible to insert a new node. That is to say, you put in a new node, with links on either side and treat them as a single link or edge that is assigned with the cost of the two links and the addition of the new node. Adding such a new node may in some cases be cheaper than other routes. Thus we set the cost of the contracted edge as the sum of costs of the edges in Q. Also, we set a parameter range, denoted φ, of the contracted edge to be the length of the path. And so, in G, all potential parents of a vertex v share an edge with v. We use G for constructing M and T. See algorithm 1 for the pseudo-code of this procedure.

Algorithm 1 PotentialParents( [symbol] , H, υ)

| 1: | Compute a modified BFS K on [symbol] starting from υ: If a visited vertex is in | | | | |
|---|---|---|---|---|---|
| | H, do not add its neighbors to the spanning queue. | | | | |
| 2: | for each leaf u in K do | | | | |
| 3: | \| | If parent of u in H ≠ υ then | | | |
| 4: | \| | \| | Add e = (u, υ) to [symbol] . Initialize CF(e) = 0, φ(e) = 0. | | |
| 5: | \| | \| | for each edge e′ = (q₁, q₂) from υ to u in K do | | |
| 6: | \| | \| | \| | φ(e) = φ(e) + 1 | |
| 7: | \| | \| | \| | CF(e) = CF(e) + CF(e′) | |
| 8: | \| | \| | \| | if q₂ ∈ Vₒ then | |
| 9: | └ | └ | └ | └ | CF(e) = CF(e) + CF(q₂) |

Let v∈P be a vertex we wish to expand on. Going forward, we consider a vertex v as its own ancestor and its own offspring in H. Let u be a child of v according to H. Then, we add u to C. If there is a vertex p∈P that is an offspring of u according to H, then we mark u as a limited vertex. We add an edge to M between u and v. Later, we will see that as we add a vertex to the set P, we add several copies of the vertex. In this sense, u connects to all copies of v in P. In addition, we add u to T as a child of v.

Algorithm 2 ExpandVertexFromP(P, H, υ)

| 1: | R = 0 | | | |
|---|---|---|---|---|
| 2: | for u in the children of υ in H do | | | |
| 3: | \| | Add u to R. | | |
| 4: | \| | for each vertex w in the subtree rooted in u do | | |
| 5: | \| | \| | if w ∈ P then | |
| 6: | \| | \| | \| | Mark u as limited. |
| 7: | └ | └ | └ | break |

| | |
|---|---|
| 8: | return R |

Next, we describe expanding a vertex v∈C. Let u be a potential parent of v according to G. We can use u in P under the following conditions. Let K be the set of ancestors of u according to H. If there is a vertex in the set K∩C which is not limited, then we ignore u. Otherwise, if v is a limited vertex, we add u to P only if r_{H}(u)≤α—d(v)−φ(u, v)) where φ(u, v)) is the distance value of the edge (u, v). If v is not a limited vertex, we add u to P only if r_{H}(u)≤α−d (v)−φ((u, v)) where d (v) is the depth of the subtree rooted in v.

As we add u to P, we add δ−1 copies of it (δ copies if u∈S) and add an edge between v and each copy. If we added u to P, then we also add u as a child of v in T. The procedures for expanding each vertex can be found in algorithms 2 and 3.

Algorithm 3 ExpandVertexFromC(C, [symbol] , H, υ)

| 1: | R = 0 | | | |
|---|---|---|---|---|
| 2: | for each neighbor u of υ in [symbol] do | | | |
| 3: | \| | if u is a child of υ in H then | | |
| 4: | \| | └ | continue | |
| 5: | \| | for each ancestor w of u in H do | | |
| 6: | \| | \| | if w ∈ C and w is not limited then | |
| 7: | \| | └ | └ | continue |

| 8: | \| | if υ is limited and r_{H}(u) > r_{H}(υ) − φ((u, υ)) then | |
|---|---|---|---|
| 9: | \| | └ | continue |
| 10: | \| | if υ is not limited and r_{H}(u) > α − d(υ) − φ((u, υ)) then | |
| 11: | \| | └ | continue |

| | | |
|---|---|---|
| 12: | └ | Add u to R |

| | |
|---|---|
| 13: | return R |

### Finding Updates to the Spanner

Using this construction, we iteratively build M and T. We stop the construction in one of two cases. If we visit a potential parent u of some vertex v such that

$$Δ H ( u ) < δ ,$$

we scan the path from u to w in T, denoted \hat{ }Q. We add to H all edges in \hat{ }Q/H and remove from H any edges in \hat{ }Q∩H. We then return H as an output.

The second case in which we terminate the construction is if there are no new vertices that can be added to M by expanding the subsets Por C. In this case, we perform the MWMM algorithm on M. We initialize a new spanner H′=H and update H′ such that each vertex in C is reconnected to the parent matched to it in P. If w is not connected by an edge in H′, we return that the connection was a failure. Otherwise, we mark was a blue vertex. Algorithm 4 provides pseudo-code for this procedure. As a result of this update, we might have components in H′ that do not have a path to the set S. We handle these components separately as discussed below.

Algorithm 4 FindConnection( [symbol] ,H, w)

| 1: | P = 0,C = {w}. | | | | |
|---|---|---|---|---|---|
| 2: | Initialize M as a bipartite graph from P and C. | | | | |
| 3: | Initialize a tree T = {w}. | | | | |
| 4: | [symbol] ** Span P and C alternately, starting with P ** | | | | |
| 5: | toSpan = {w}, spanning = P, nextSpan = 0. | | | | |
| 6: | spanFunction = ExpandVertexFromC | | | | |
| 7: | while toSpan is not empty do | | | | |
| 8: | \| | Pop a vertex υ from toSpan | | | |
| 9: | \| | [symbol] | ** Expand the current type of expansion ** | | |
| 10: | \| | expansion = spanFunction( ) | | | |
| 11: | \| | for u in expansion do | | | |
| 12: | \| | \| | | if u not in spanning then | |
| 13: | \| | \| | | \| | Add u to nextSpan |
| 14: | \| | └ | | └ | Add u as a child of υ in T |
| 15: | \| | [symbol] | For each parent found, check if it ends the search. If not, create | | |
| | | | copies of it ** | | |
| 16: | \| | if spanFunction = ExpandVertexFromC then | | | |
| 17: | \| | \| | | for u in expansion do | |
| 18: | \| | \| | | └ | if Δ_{H}(u) < δ then return The path from w to u in T. |
| 19: | \| | └ | | Duplicate each vertex in expansion δ − 1 times. | |
| 20: | \| | [symbol] | ** Build M ** | | |
| 21: | \| | for each u in expansion do | | | |
| 22: | \| | \| | | if u not in spanning then | |
| 23: | \| | \| | | └ | Add u to spanning |
| 24: | \| | └ | | Add (u, υ) to M. | |
| 25: | \| | if toSpan is empty then | | | |
| 26: | \| | \| | | toSpan = nextSpan | |
| 27: | \| | \| | | nextSpan = 0 | |
| 28: | \| | \| | | [symbol] ** Swap the spanning type for next iterations ** | |
| 29: | \| | \| | | if spanFunction = ExpandVertexFromC then | |
| 30: | \| | \| | | \| | spanFunction = ExpandVertexFromP |
| 31: | \| | \| | | \| | spanning = C |
| 32: | \| | \| | | else | |
| 33: | \| | \| | | \| | spanFunction = ExpandVertexFromC |
| 34: | └ | └ | | └ | spanning = P |

| | |
|---|---|
| 35: | return MWMM(M) |

### Connecting Disconnected Components

Let \hat{ }H be the graph containing all components connected to the set S. For each component J not in \hat{ }H, we contract J to a red vertex v, it being recalled that the red vertices are the disconnected vertices. Let \hat{ }G be the graph containing \hat{ }H and all contracted red vertices. For each red vertex v, let e=(u, q) be an edge in G such that u∈J and q∈\hat{ }H. If u is not a blue vertex, we add e to \hat{ }G. We then attempt to connect the contracted red vertices using an edge from \hat{ }G. Notice that for the condition of limited vertices, we need to consider the depth of the component J. And so, a potential parent p of v can be added to P only if r_{\hat{ }H}(p)<α−dᵤ(v)−φ((q, u)) where dᵤ(v) is the depth of component J if rooted in u.

If the connection was successful, let e=(q, u) be the edge connecting the contracted vertex v to the updated spanner \hat{ }H. We span J starting from u and make q the parent of u in \hat{ }H.

We mark u as a blue vertex and use \hat{ }H for the connection attempt of the next disconnected component. We repeat this process until no disconnected components remain. If the attempt to connect the contracted red vertices fail, we do not accept the connection of the red vertex w to H. If w was successfully connected while no new red vertices were added in the process, then we set H=\hat{ }H

### Proof of Wholeness

We prove the correctness of the algorithm in this section. Specifically, we show that if the algorithm returns a spanner H, then H is whole. We prove each of the conditions for wholeness in a different lemma. But first, we state the correctness of the algorithm in the following theorem.

Theorem 1. Let H be a spanner of a graph G such that r(H)≤α and Δ(H)≤δ. Let w be a vertex not in H. If the algorithm we presented returns a spanner H′, then H′ is whole. That is, r(H′)≤α; _Δ(H′)≤δ, and Vᵣ(H)U{w}∈H′.

We begin with proving the condition on the degree of H′.

Lemma 1. Δ(H′)≤δ.

Proof. The updates to H, represented in H′, can come from two cases. We first prove the lemma in the case the update was chosen from the tree T. In this case, we have a path Q from w to some vertex u. Notice the u is a potential parent of some vertex v₁ which is the parent of u in T. Furthermore, ΔH(u)<δ as per the requirement in the algorithm. In the update, we direct the edge from v₁ to u making u the parent of v/in the spanner. The parent of v₁ in T, denoted v₂, is the previous parent of v₁ in H. Since now v₁ has a new parent, and since Δ(H)≤δ, after the update we have that Δ(v₂)=δ−1. Again, v₂ is the potential parent of v₃ which is the parent of v₂ in T. In the update, we direct the edge from v₃ to v₂ and thus reducing the degree of the previous parent of v₃ in H. This propagates up the path Q. Thus, every vertex vᵢ∈Q has degree ΔH′ (vᵢ)≥δ after the update. Only vertices along Q are updated in terms of their adjacent edges changing their degree. Therefore, all vertices in H′ have degrees smaller than or equal to δ in this case.

The second case in which we update adjacent edges is as a result of the MWMM on M. Let v∈C be a vertex which was updated. The update on vertices in C removes a single edge from v to a previous parent and adds a new edge connecting v to a new parent if possible. This operation does not increase the degree of v. For a vertex u∈P, we create δ−1 copies for u in P. Each copy can have at most one edge connected to it in a match. Therefore, u can have at most δ−1 edges connected to it after the match. Since we only compute the matching on U if all of its children in H are also in M, the matches of the copies of u are the only connections it has for children in H′. The parent of u is one more edge connecting to u. That is, Δ_{H′}(u)≤δ.

We now prove the condition for the depth of H′.

Lemma 2. For each v∈H′, r(v)≤α.

Proof. For each v we inspect the change in the rank of v in H′ compared to its rank in H. A vertex can have its rank changed in one of two cases. The first is if v was reconnected to a different parent in H′. Let p be the parent of v in H′ such there is no ancestor of p in M. The edge (p, v) was added to T and M only since p is a potential parent of v which upholds

$$r H ( p ) \leq α - {d}_{H} ( v ) - ϕ ( ( p , v ) )$$

Since there is no ancestor of p in M, p could not have changed its rank. Thus,
r_{H′}(p)=r_{H}(p). Then we have

$$\begin{matrix}{r}_{{H}^{′}} ( v ) & = {r}_{{H}^{′}} ( p ) + ϕ ( ( p , v ) ) \\ & = {r}_{H} ( p ) + ϕ ( ( p , v ) ) \\ & \leq α - {d}_{H} ( v ) - ϕ ( ( p , v ) ) + ϕ ( ( p , v ) )\end{matrix} \qquad ( 2 )$$

Therefore, rH′ (v)≤α. Now, assume that p does have an ancestor v₂ in M that might change its rank. Again, it can occur if v₂ is connected to a different parent p₂ than its parent in H. We repeat the claim we provided for p₁ but for p₂. Notice that here, v₂ would be a limited vertex, and thus we have r_{H}(p₂)≤r_{H}(v₂)−φ((p₂; v₂))

Therefore,

$$\begin{matrix}{r}_{{H}^{′}} ( {v}_{2} ) & = {r}_{{H}^{′}} ( {p}_{2} ) + ϕ ( ( {p}_{2} ; {v}_{2} ) ) \\ & = {r}_{H} ( {p}_{2} ) + ϕ ( ( {p}_{2} ; {v}_{2} ) ) \\ & \leq {r}_{H} ( {v}_{2} ) - ϕ ( ( {p}_{2} , {v}_{2} ) ) + ϕ ( ( {p}_{2} ; {v}_{2} ) )\end{matrix} \qquad ( 3 )$$

It follows that r_{H′}(v₂)≤r_{H}(v₂) and r_{H′}(p)≤r_{H}(p). Thus, r_{H′}(v)≤α. In general, for a new parent pi of a vertex vᵢ, if there is a vⱼ which is an ancestor of pᵢ, then r_{H′}(vⱼ)≤r_{H}(vⱼ) and therefore r_{H′}(pᵢ)≤r_{H}(pᵢ). If there is no such vⱼ, then

$$\begin{matrix}{r}_{{H}^{′}} ( {v}_{i} ) & = {r}_{{H}^{′}} ( {p}_{i} ) + ϕ ( ( {p}_{i} , {v}_{i} ) ) \\ & = {r}_{H} ( {p}_{i} ) + ϕ ( ( {p}_{i} , {v}_{i} ) ) \\ & \leq {r}_{H} ( {v}_{i} ) - ϕ ( ( {p}_{i} , {v}_{i} ) ) + ϕ ( ( {p}_{i} , {v}_{i} ) )\end{matrix} \qquad ( 4 )$$

and thus r_{H′}(vᵢ)≤α.

The second case is where v is in a subtree of a vertex u that was reconnected to a different parent in H′. From what we have just shown, we can have two cases. One is where r_{H′}(u)≤r_{H}(u), in which case r_{H′}(v)≤r_{H}(v). The other case, is where the parent of u, denoted p, is such that

$${r}_{H} ( p ) \leq α - {d}_{H} ( u ) ϕ ( ( p ; u ) )$$

Then we have

$$\begin{matrix}{r}_{{H}^{′}} ( v ) & = {r}_{{H}^{′}} ( u ) + {dist}_{{H}^{′}} ( u , v ) \\ & = {r}_{{H}^{′}} ( u ) + {dist}_{H} ( u , v ) \\ & = {r}_{H} ( p ) + ϕ ( ( p , u ) ) + {dist}_{H} ( u , v ) \\ & \leq α - {d}_{H} ( u ) + ϕ ( ( p , u ) ) - ϕ ( ( p , u ) ) + {dist}_{H} ( u , v )\end{matrix} \qquad ( 5 )$$

$$Since {dist}_{H} ( u , v ) \leq {d}_{H} ( u ) we have {r}_{{H}^{′}} ( v ) \leq α . \qquad □$$

Finally, we prove that all required vertices contained in H are also in H′ as well as the vertex w.

Lemma 3. Vr(H)U{w}∈H′.

Proof. The proof is straightforward by contradiction. Assume that there is a vertex v in Vr(H)U{w} which is not in H′. Then, as we scan for disconnected components after an update, we mark all such vertices as red vertices. If the set of red vertices does not empty, we do not accept the connection attempt of w and return a failure. Thus, if the algorithm returns H′ as a new spanner, there are no red vertices. This constitutes a contradiction.

The three lemmas accordingly conclude the correctness of theorem 1.

### Runtime Analysis

We present an analysis of the worst case running time of the algorithm in this section. Let n=|V|, m=|E|. For the construction of G, the algorithm spans BFS trees. Each BFS requires O(m) time while we have at most n such spanning trees. Therefore, it takes O(mn) time to construct G. For constructing M and T notice that each edge in G can be added at most once. Thus, the algorithm requires O(m) time for this construction. Finally, in the worst case, we execute the MWMM on M using the Hopcroft-Karp Algorithm in O(√n·m) time. Then, we iteratively handle unconnected components. Note that as we attempt each such component, we do not allow rooting the component in a blue vertex as we mark each such root from previous iterations as blue and do not use edges from blue vertices to \hat{ }H for the purpose of connecting the contracted red vertex v. Therefore, each successful connection of a disconnected component marks exactly one vertex as a blue vertex. As we might retry red vertices we did not manage to connect previously, there might be O(n) attempts until we manage to connect any single contracted red vertex. Therefore, we can have at most O(n²) iterations of connection attempts before all vertices are marked as blue vertices. Since we are using only non-blue vertices for possible connections of contracted red vertices, we will have no more attempts after O(n²) attempts.

To conclude, the running time of the algorithm is O(n^{2.5}·m)·m→On²

### A Quicker Search for a Connection

The algorithm presented above, denoted A, is shown to have a running time of O(n^{4.5}). As there can be n−|S| red vertices in the worst case, and as the algorithm tries O(n²) attempts at connecting all of them, the performance of the algorithm might hold some issues in big networks. In this section, we offer an algorithm A* which is more efficient but at the cost of accuracy. The algorithm A will not return an unfeasible network if the algorithm A* can find a solution. But the algorithm A* might miss on solutions that the algorithm A can find. In this sense, A* is less accurate than A.

The algorithm A* starts in the same way we started the algorithm A, with building the graph G. Then, we span a special BFS R from each red vertex w, one by one. As we span R, we span such that the ranks alternate between spanning potential parents of the previous rank and adding the rank to a subset P, and spanning children in H of the previous rank and adding the rank to a subset C. But not all possible vertices are added in each rank. Let v be a vertex we visit in the spanning. The following conditions are applied:
If v is to be added to P and is already in P, it is not added to R. Otherwise (v∈C or in none of the subsets), it is still added to R and, therefore, also to P.
Let Q be the path from v to the root of R and consider H′ which is the resulting spanner of updating H using the update represented by Q. If there is a vertex u∈Q such that r_{H}(u)>α, we do not add v to R. Note that v could be added by a different path in R during the following iterations in the spanning.
If v is successfully added to the subset P and ΔH(v)<δ, we do not continue spanning from v and consider v as a green leaf in R.
If v is added to R and we cannot span a rank under v, then v is considered a black leaf in R.

Let Q₁; : : : ; Q/be the set of all paths in R from the root to any green leaf. We choose \hat{ }Q such that max_{e∈\hat{ }Q}(CF(e))=min_{1<i<I}/(max_{e∈Qi}(CF(e))). That is, \hat{ }Q is the path where the maximum between all costs of edges along the path is minimal. We then traverse \hat{ }Q and add to H all edges in \hat{ }Q/H and remove from H any edges in \hat{ }Q∩H. We return H as an output. If no green vertices exist in R, we retry the algorithm using DFS instead of BFS.

The running time of this algorithm relies on the time it takes to scan the path Q from the root of R to a vertex v as we wish to add v to R. Even naively, this can be done in O(n) time. Therefore, the algorithm A* runs in O(nm) time, which is an improvement over the algorithm A. Furthermore, the algorithm A* has less steps than the algorithm A, making it more efficient in practice. As to the correctness of the algorithm, since we make sure to span v for which the path Q does not violate a, this requirement holds for the output of the algorithm. As for the δ requirement, note that the leaf v of Q has degree smaller than δ. Thus, the parent u of v in R is a vertex that can connect to v such that v becomes the parent of u in H. Thus, the parent of u in R now has a degree smaller than δ. This propagates up the path Q until we reach the red vertex w. Thus, w can connect to H and all vertices that were updated have degree smaller than δ+1 as required. To conclude, His whole.

### Minimizing the Maximum Cost

In this section we attempt to minimize max_{e∈H} CF_{H}(e). The algorithm is a greedy algorithm that progresses in iterations. Our goal in each iteration is to update H such that maximum between the costs of the edges in H decreases by at least a given parameter ε>0. At first, we define all edges in H as non-red edges. In each iteration, we find e=(v, u) the most expensive edge. We ignore the edge e from the spanner H thus making u a red vertex. We then use the same procedure as described hereinabove. If we do not have a feasible spanner as a result, we mark e as a red edge. Otherwise, let H′ be the resulting spanner.

Let \hat{ }E be the set of non-red edges. Then if max_{e∈\hat{ }E} CF_{H′}(e′)−ε≤CF_{H}(e), we accept the change and update H=H′. Otherwise, we mark e as a red edge. We iterate until all edges are red.

### Extending for Reliability

In this section we offer an algorithm for extending the solution H given in previous sections to adhere to the Reliability requirement as defined hereinabove.

Unlike the spanner H, we may allow some requirements to be more lenient for the alternative paths. We do this by formulating a requirement as part of the cost function. For example, the Latency requirement can be expressed as minimizing the rank of vertices used in alternative paths and not necessarily making these paths illegal in the sense of network feasibility. That is to say, for reliability we may require an extra path or two and if so we can relax the latency requirement Herein, we regard Aggregation as a requirement for the feasibility of alternative paths and the Latency as a cost.

Our algorithm starts with decreasing the value k(v) of all vertices in V (H) by 1 since H is already a 1-point-of-failure solution for each of them. Next, we find a v with the minimum value of k>0 (choosing arbitrarily if there are several such vertices). We build a new graph H′ from G in the following manner. Let χ be the union of the paths from v to S in H. Then V (H′)={u∈V (G)|Δ_{H}(u)<δ} and E(H′)={e=(u, w)∈E(G)|e∉χ, u∈V (H′), w∈V (H′)}. We now find the shortest path from v to H in H′. We do this using the Dijkstra algorithm, where each weight of an edge e=(u, w) is defined as <PW(e); r_{H}(w), CF(e)>. The Dijkstra algorithm finds the shortest path once the tree is constructed.

If no path was found, we return the output Unfeasible Network. Otherwise, we denote the resulting path as Q=(v; : : : ; r). For each vertex q∈Q, we decrease k(q) by 1. We do the same for any vertex along the path from r to its ancestor in S. Finally, we add the edges along Q to H. We repeat this process for the next vertex with minimum value of k>0. The algorithm terminates when there are no vertices in H with value of k>0.

### A Genetic Algorithm

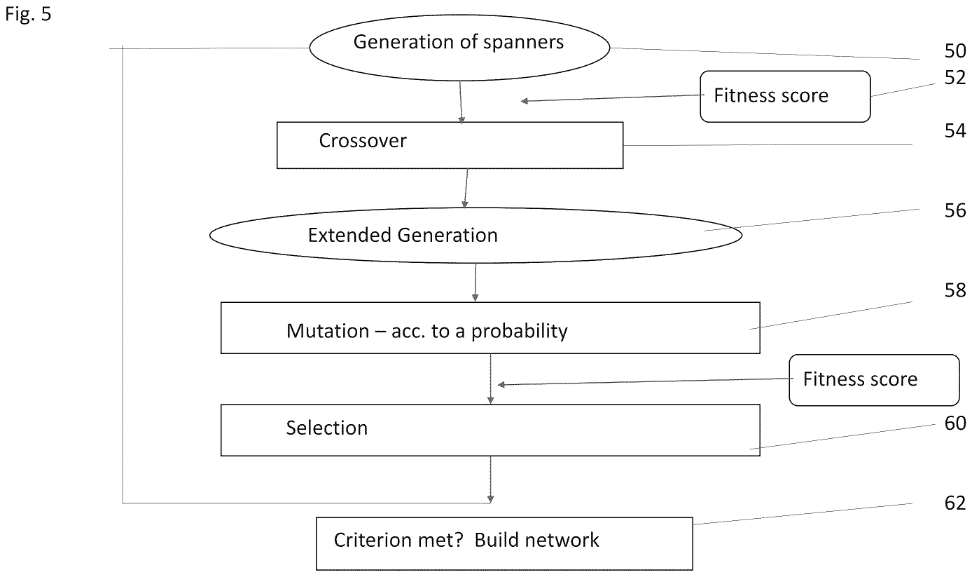

Reference is now made to FIG. 5, which is a simplified flow chart illustrating a genetic algorithm for the spanning problem and formation of the spanner. The general scheme for generic algorithms is usually the same. The genetic scheme starts with a randomly generated generation, which is a set of spanners (members), not necessarily legal—box 50. It evaluates the Fitness—box 52 of each of the solutions using a Fitness Function. According to the fitness score, we perform a Crossover—box 54—where we pair solutions and create new members that are added to the existing generation to form an extended generation—box 56. We proceed to perform Mutation at a small probability—box 58—on each member in the extended generation (the previous one in addition to the members created in the crossover). We then use Selection where, according to the fitness function, we select a subset of members from the extended generation,—box 60.

This selection becomes the new generation for following iterations of the algorithm. We repeat this process until a certain criteria is met. In the following sections, we describe each of the four core functions of the genetic schemes for our spanning algorithm.

When a preset finish criterion is met, usually when successive iterations fail to improve, then the process ends—box 62—and if appropriate the network is built.

### The Fitness Function

For a member m, let c(m)=Σ_{e∈E(m)} CF(e). The fitness score of the member is given by f(m)=−cw₁−|E(m)|w₂ where w₁,w₂ are a pair of weights given as a parameter to the algorithm. The weighting may depend on the network operator and associated priorities. Let d be the diameter of a member and Δ be its degree. Let n be the number of vertices in the input graph G. Let σ=Σ_{v∈m} max(0, rₘ(v)−α)+max(0, Δ(v)−δ).

If σ>0, we multiply f(m) by

$$μπ \sqrt{\frac{σ}{n}} \cdot exp ( {log}_{μ} ( n ) \cdot arctan ( \frac{n + 1}{n + 1 - σ} ) )$$

where μ≥1 is the magnitude of the penalty. That is, if n=μ^{r}, then the penalty escalates faster as r increases.

### The Selection Function

For each generation we choose t numbers of members of the population. Let f(m) be the fitness function of a member m in the generation M. We first select the top (1+c)t members for some constant c>0. Then, we set the probability of each member m from that list to be selected as

$$p ( m ) = \frac{{f ( m )}^{{-}_{2}}}{{\sum }_{{m}_{i} ∈ M} {f ( {m}_{i} )}^{2}}$$

On this distribution, we choose t members without repetitions using a reverse square probability. It is now highly probable that fitter members are chosen but less fit members may be chosen, albeit with lower probability.

### The Crossover and Mutation Functions

In this section, we describe both the crossover function and mutation function. This is since the difference between the two functions is only in the selection of the vertex or edge we wish to update. In the mutation function, we simply choose an vertex or an edge in a member in random and update it. In the crossover function, we need to first match the members in a generation with a correlation to their fitness function. Let f(m₁); f(m₂) be the fitness score of members m₁,m₂. We build a new weighted graph M with a vertex representing each member in the generation. We add an edge between two members with a weight |f(m₁)−f(m₂)|. We then perform a greedy matching on M. In each iteration, we choose the edge with the smallest weight. Once a maximal matching is achieved, each pair of matched members exchange elements between them.

We start with describing changes to the edge set of a member. Given an edge e∈G and a member m∈M, the member is updated to contain e while forgoing at least one other edge e′∈m. Let m₁, m₂ be two members in generation M. The selection of edges for an update in the crossover function starts with scanning the members and constructing an edge subset A₁={e∈m₁|e∉m₂}.

Similarly, we construct the edge set A₂={e∈m₂|e∉m₁}. For each edge in these subsets, we define the weight of selection as <CF(e)>. We choose a random number c>0 of edges out of each of the subsets A₁, A₂ using the weighted distribution on the weights of the edges. The selection of edges in the mutation function is done by choosing a random number c′>0 of edges in a member using the same distribution. We proceed to update the selected edges in the following manner. Let e=(v, u) be an edge we wish to add to a member m. The update of e is as follows:
1. If v, u∈m, find the Lowest-Common-Ancestor (LCA) r of v, u.
(a) If r=v, disconnect u from the most costly edge connecting it to its parents in m.
(b) Else, if r=u, disconnect v from the most costly edge connecting it to its parents in m.
(c) Else, disconnect the vertex with the higher rank between the two.
(d) Add e to m and direct it towards the vertex that was disconnected, making it the child of the other one.
2. If neither vertices are in m, we assume without loss of generality that v is the parent of u in
M′ (or the vertex with the lower rank in case of mutation).
(a) We span a BFS in m′ (of G in case of mutation) from v and stop once we find the shortest path (regardless of weights) from v to some vertex in m.
(b) We then add all vertices and edges along that path to m.
(c) We add e to m directing it such that u is the child of v.
3. If only one vertex is in m, then we may assume without loss of generality that v∈m. Then we simply add e to m and direct it such that u is the child of v.

We address removing optional vertices from m separately. We say a vertex w∈m is a reachable parent of a vertex u if r(w)<α; Δ(w)<Δ and LCA(u, w) is not u itself. We say that v∈Vo is removable if each child u of v in m has a reachable parent in m which is not v, or can have one by adding an edge from E(G) to m. For each removable vertex v we define the selection weight as the sum of costs of the edges adjacent to it in m. We select c″>0 removable vertices in random using this weighted distribution. We remove each of the selected vertices from v and reconnect its children to m using the least costly edges.

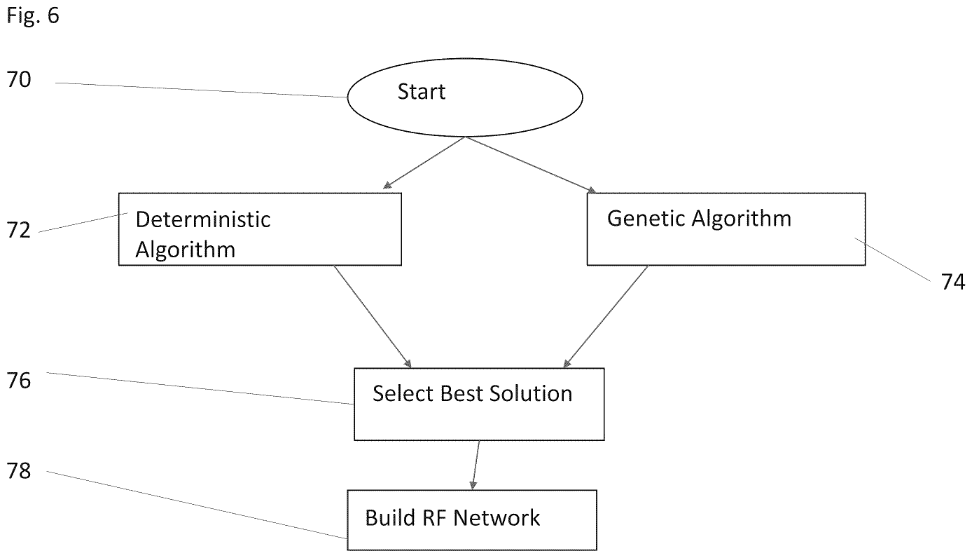

Reference is now made to FIG. 6, which is a simplified flow chart illustrating how a simplified scheme may combine the deterministic and genetic algorithms to arrive at a best achievable spanner on which to base the building of the network. The combined method starts—box 70—by seeding both methods, the deterministic—box 72 and the genetic box 74—algorithms. Each method proceeds as above to produce its best solution. The two solutions are compared for cost and feasibility—box 76—and the RF network is built accordingly—box 78.

The advantage of the combined procedure of FIG. 6 is that each process on its own is liable to get caught out by a local maximum. However the chances of two completely different procedures being caught out by the same local maximum is small, and the chances that at least one of them will find a global maximum is greatly improved.

### General

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of building a communication network, the network having a first number of predefined core vertices and a second number of optional vertices, and edges extending directionally between ones of said vertices, each edge having a cost, the network predefined feasibility requirements, said feasibility requirements comprising at least one of a capacity requirement, a maximum allowed latency, a maximum aggregation and a reliability, the method comprising:
building an initial solution by connecting edges between said vertices such that said initial solution fulfils said feasibility requirements, said initial solution prioritizing edges between two of said core vertices and deprioritizing edges between two optional vertices, then adding unconnected vertices one by one;
ordering said edges according to cost;
tentatively removing a costliest one of said edges and checking whether said feasibility requirements are still met;
if said feasibility requirements are met then accepting the removal of said costliest edge, otherwise reinstating said edge;
continuing with a next costliest edge until all edges that can be removed while maintaining said feasibility requirements are removed and remaining ones of said edges are maintained; and
completing said communication network such that each remaining edge is implemented as a communication link.

2. The method of claim 1, wherein one or more vertices are disconnected after removing edges and maintaining feasibility requirements, the method comprising sequentially connecting said disconnected vertices by spanning said network using a breadth first search (BFS) from a respective disconnected vertex, said search comprising finding potential parent vertices of said respective disconnected vertex and adding edges from said respective disconnect vertices to said parent vertices, and retaining lowest cost ones of said potential edges, provided said feasibility requirement are complied with.

3. The method of claim 2, comprising continuing to reconnect disconnected vertices until all vertices are connected to said network, and if it is not possible to connect all vertices and comply with said feasibility requirements then determining that said communication network is unfeasible.

4. The method of claim 1, comprising adding a new vertex, the method comprising spanning said network using a breadth first search (BFS) from said new vertex, said search comprising adding from said new vertex to respective potential parent vertices of said new vertex and retaining lowest cost ones of said edges, provided said feasibility requirement are complied with.

5. The method of claim 2, comprising adding a new vertex and edges on either side as a potential new parent vertex.

6. The method of claim 1, comprising using said maximum allowed latency as a cost.

7. The method of claim 1, comprising treating said aggregation as a requirement.

8. The method of claim 1, comprising requiring redundancy, such that there are always at least two alternative independent routes between each vertex.

9. A method of building an RF communication network, the network having a first number of predefined core vertices and a second number of optional vertices, and edges extending directionally between ones of said vertices, each edge having a cost, the network predefined feasibility requirements, said feasibility requirements comprising at least one of a capacity requirement, a maximum allowed latency, a maximum aggregation and a reliability, the method comprising:
randomly generating a plurality of spans of said vertices;
evaluating said plurality of spans for fitness;
using said fitness, pairing solutions and creating crossover solutions to add to said spans;
performing a mutation on some of said spans;
selecting a new generation from said spans using said fitness evaluation and continuing with further generations until a stop criterion is met; and
completing said RF communication network such that edges in a last remaining span are implemented as communication links in said RF network.

10. A method of building an RF communication network, the network having a first number of predefined core vertices and a second number of optional vertices, and edges extending directionally between ones of said vertices, each edge having a cost, the network predefined feasibility requirements, said feasibility requirements comprising at least one of a capacity requirement, a maximum allowed latency, a maximum aggregation and a reliability, the method comprising:
using a deterministic algorithm to find a first optimum solution for a feasible spanning of said network;
using a genetic algorithm to find a second optimum solution for a feasible spanning of said network;
selecting between said first optimum solution and said second optimum solution; and
building said RF communication network such that edges of said selected optimum solution are implemented as communication links in said RF network.

11. The method of claim 10, wherein said deterministic algorithm comprises:
building an initial solution by connecting edges between said vertices such that said initial solution fulfils said feasibility requirements, said initial solution prioritizing edges between two of said core vertices and deprioritizing edges between two optional vertices, then adding unconnected vertices one by one;
ordering said edges according to cost;
tentatively removing a costliest one of said edges and checking whether said feasibility requirements are still met;
if said feasibility requirements are met then accepting the removal of said costliest edge, otherwise reinstating said edge;
continuing with a next costliest edge until all edges that can be removed while maintaining said feasibility requirements are removed and remaining ones of said edges are maintained.

12. The method of claim 10, wherein said genetic algorithm comprises:
randomly generating a plurality of spans of said vertices;
evaluating said plurality of spans for fitness;
using said fitness, pairing solutions and creating crossover solutions to add to said spans;
performing a mutation on some of said spans;
selecting a new generation from said spans using said fitness evaluation and continuing with further generations until a stop criterion is met.

13. An R.F. network constructed using the method of claim 1.

14. An R.F. network in which at least one communication node is added as a new vertex according to the method of claim 4.
